(19) United States
(12) Patent Application Publication
(10) Pub. No.: US 2014/0110115 A1
(43) Pub. Date: Apr. 24, 2014

(54) Gelling Agents and Methods of Using the Same

(71) Applicant: HALLIBURTON ENERGY SERVICES, INC., Houston, TX (US)

(72) Inventors: B. Raghava Reddy, Houston, TX (US); Hsin Chen Chung, Houston, TX (US); Wirdansyah Lubis, Duncan, OK (US)

(73) Assignee: Halliburton Energy Services, Inc., Houston, TX (US)

(21) Appl. No.: 13/654,640

(22) Filed: Oct. 18, 2012

(51) Int. Cl. C09K 8/42; E21B 43/16; E21B 33/13

(52) U.S. Cl. 166/294; 166/305.1; 507/214; 507/216

(57) ABSTRACT

Additives are used in treatment fluids in subterranean operations to prevent fluid loss within a subterranean formation. A method includes providing a treatment fluid that includes a viscosifying polymer and a solid-liquid phase transition temperature modifier and placing the treatment fluid in a subterranean formation penetrated by a wellbore, wherein the solid-liquid phase temperature modifier is added in an amount to modulate the gelling temperature of the viscosifying polymer to a target temperature.

### BACKGROUND

The present invention relates to additives used in treatment fluids in subterranean operations. More specifically, the present invention relates to gelling agents and methods of their use to divert treatment or formation fluids, prevent fluid loss within a subterranean formation, block permeability to fluid flow, or form a temporary chemical plug.

Gelling agents have been used in the context of numerous subterranean operations for simple plugging and fluid loss control, as well as to divert fluids from one portion of a formation to another. Fluid loss of wellbore treatment fluids such as fracturing, acidizing, drilling, and gravel packing fluids into a subterranean formation is generally undesirable in oilfield operations. Unwanted formation water production into the wellbore and temporary blocking of flow channels, e.g., diverting fluids, during well completions and/or stimulation, are also examples of where the modulation of fluids within a formation is desirable.

Various gelling agents have been developed to reduce fluid loss, prevent unwanted water production and for fluid diversion. Exemplary compositions for these purposes include metal- and organically-crosslinkable gelling agents such as cellulose derivatives (e.g., hydroxyethylcellulose (HEC)), guar, polyacrylamides, and the like.

Recent advances have led to gelling agents that rely on stimuli-sensitive, non-crosslinked viscosifying systems based on thermally viscosifying polymers. In such systems, the viscosifying polymers exhibit a temperature-dependent viscosity and are designed to remain flowable and provide suitable particle suspension for drill cuttings, sand, and gravel, for example. In the case of some thermally viscosifying polymer systems, sharp phase transitions from liquid to solid at specific temperatures are observed. Such polymer systems are more suited to simple permeability plugging operations if the application temperatures exceed the polymer phase transition temperatures. The liquid to solid transitions are generally sharp and well defined and unique to each polymer. Other than altering the polymer structure itself, there are no apparent means by which the transition temperature has been modulated in the art. Thus, in operation, one relying on temperature dependent viscosifying polymers may employ an array of polymer structures with different phase transition temperatures to cover the entire application temperature range in the field. Such a strategy is generally not very cost-effective.

### SUMMARY OF THE INVENTION

The present invention relates to additives used in treatment fluids in subterranean operations. More specifically, the present invention relates to gelling agents and methods of their use to plug permeability to treatment or formation fluid flow, divert treatment or formation fluids, or prevent fluid loss within a subterranean formation.

In some embodiments, the present invention provides a method comprising modulating the liquid-solid phase transition temperature of a thermally gelling polymer by adding a solid-liquid phase transition temperature modifier to the thermally gelling polymer.

In some embodiments, the present invention provides a method comprising providing a treatment fluid comprising a thermally gelling polymer and a solid-liquid phase transition temperature modifier, and placing the treatment fluid in a subterranean formation penetrated by a wellbore, wherein the solid-liquid phase transition temperature modifier is added in an amount to modulate the gelling temperature of the viscosifying polymer to a target temperature.

In other embodiments, the present invention provides a method comprising providing a treatment fluid comprising a glycerine carbonate-modified water soluble cellulose ether and a surfactant or a non-surface active organic salt, and placing the treatment fluid in a subterranean formation penetrated by a wellbore.

In still other embodiments, the present invention provides a method comprising providing a treatment fluid comprising a glycerine carbonate-modified water soluble cellulose ether and a surfactant or a non-surface active organic salt, and placing the treatment fluid in a subterranean formation penetrated by a wellbore.

In still other embodiments, the present invention provides a method comprising providing a treatment fluid comprising an organic carbonate-modified water soluble cellulose ether and a surfactant or a non-surface active organic salt, and placing the treatment fluid in a subterranean formation penetrated by a wellbore to provide fluid loss control.

In still other embodiments, the present invention provides a method comprising providing a treatment fluid comprising an organic carbonate-modified water soluble cellulose ether and a surfactant or a non-surface active organic salt and placing the treatment fluid in a subterranean formation penetrated by a wellbore to reduce water influx into the wellbore.

In still other embodiments, the present invention provides a method comprising providing a first treatment fluid comprising an organic carbonate-modified water soluble cellulose ether and a surfactant or a non-surface active organic salt; placing the first treatment fluid in a first portion of a subterranean formation penetrated by a wellbore; placing a second treatment fluid in the wellbore, wherein the second treatment fluid is diverted away from the first portion of the subterranean formation.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a heating-cooling viscosity curve for 1% METHOCEL® in water.

FIG. 2 is a photograph of the 1% METHOCEL® at room temperature (solution) and at 65° C. (gel).

FIG. 3 is an overlay of the heating-cooling viscosity curves for METHOCEL® and METHOCEL® modified with glycerine carbonate (GC).

FIG. 4 is an overlay of the heating-cooling viscosity curves for METHOCEL® modified with glycerine carbonate (GC) under oscillatory conditions at 1 Hz.

FIG. 5 is an overlay of plots showing the gelling temperature of METHOCEL™ modified with glycerine carbonate (GC) with varied concentrations of the surfactant sodium dodecyl sulfate (SDS).

FIG. 6 is an overlay of plots showing the gelling temperature of METHOCEL™ with different organic salts.

FIG. 7 is a plot of the permeability versus pore volume for a treatment fluid comprising METHOCEL® modified with glycerine carbonate (GC).

### DETAILED DESCRIPTION

The present invention relates to additives used in treatment fluids in subterranean operations. More specifically, the present invention relates to gelling agents and methods of their use to divert treatment or formation fluids, prevent fluid loss within a subterranean formation, block permeability to fluid flow, or form a temporary chemical plug.

Among the numerous advantages, methods of the invention provide single-polymer component gel systems that do not require crosslinking. The self-gellation mechanism provides gelling agents with phase transition temperatures that are readily modulated with solid-liquid phase temperature modifiers. As used herein, the term “solid-liquid phase transition temperature modifier(s)” refers to a chemical agent(s) that alters the solid to liquid or liquid to solid phase transition temperature of the gelling agent, thus allowing the temperature at which a gel forms or breaks down to increase or decrease fluid viscosity or gel stiffness respectively. As is known to those skilled in the art, all phase transition phenomena are reversible at the phase transition temperatures. Even though the phase transition is referred to as solid-liquid phase transition, the term “solid” may be used interchangeably with “gel” which may be flowable or non-flowable, deformable or non-deformable and rigid. The term “solid-liquid phase transition” may also be referred to as “gel-liquid phase transition,” “liquid-gel phase transition” or “sol-gel phase transition.” As known in the art, the temperature at which a polymer undergoes phase transition may also be referred to as lower critical solution temperature (LCST) behavior or “cloud point” temperature. It is to be noted that such different terminology may also apply to polymer systems which, upon phase transition, may undergo phase separation, for example, into polymer-rich phase and polymer-depleted phase, or simply polymer separation as a milky granular solid suspended in a thin aqueous fluid. In the present invention, the term “solid-liquid phase-transition” may refer to a phase transition from a flowable viscous solution to a gelled phase wherein the entire liquid is converted into a stiff visco-elastic to elastic gel. It should also be noted that the term “solid-liquid phase transition” does not necessarily restrict the phase transition from solid to liquid phase. The term may be descriptive of the liquid to solid (gelled) phase also. It will be understood by those skilled in the art that the direction of temperature change defines the direction of the physical states of the phases that are converted. In some embodiments, the solid-liquid phase temperature modifier may be a surfactant or a non-surface active organic salt to modulate the gellation temperature of the polymer. In embodiments employing cellulose ethers, in particular, such gelling systems are less sensitive to the presence of salts, and are therefore compatible with treatment fluids such as brines.

Other particular advantages in certain embodiments include the use of commercially available modified celluloses, which can be utilized off the shelf as the single-polymer gelling agent in conjunction with the solid-liquid phase temperature modifiers. Such single component gelling systems can utilize different amounts of solid-liquid phase temperature modifiers at different times during subterranean operations to alter the solid-liquid phase transition temperature in real time. In other embodiments, it has been indicated that treatment of modified cellulose ethers, in particular, water soluble modified cellulose ethers, with organic carbonates can advantageously provide a single component gelling system that is also responsive to solid-liquid phase transition temperature modifiers, the organic carbonate modification further allowing a reduction in the amount of polymer necessary in various operations.

As specific examples of the above advantages, it has been indicated that the thermally induced liquid-solid phase transition temperature for a thermally gelling cellulose ether polymer, methylcellulose (METHOCEL®, The Dow Chemical Company), can be modified with the addition of an anionic surfactant, or a non-surfactant organic salt. The shift in gellation temperature was dependent on the amount of surfactant added. A similar behavior may be obtained for the non-surface active organic salt. One such exemplary anionic surfactant for this purpose is sodium dodecyl sulfate (SDS). Further, by chemically modifying methylcellulose with organic carbonates, such as glycerine carbonate, the viscosity of polymer solutions at temperatures below gellation temperatures and gel elasticity above gellation temperature could be increased, which may allow reduced amounts of the polymer system in operation, while maintaining, for example, particle suspension below gellation temperatures.

In some embodiments, the present invention provides methods comprising providing treatment fluids comprising thermally gelling polymers and solid-liquid phase transition temperature modifiers, and placing the treatment fluids in subterranean formations penetrated by wellbores, wherein the solid-liquid phase transition temperature modifier is added in an amount to modulate the gelling temperature of the viscosifying polymer to a target temperature. In some such embodiments, methods of the invention comprise providing a treatment fluid comprising a glycerine carbonate-modified water soluble cellulose ether and a surfactant, and placing the treatment fluid in a subterranean formation penetrated by a wellbore. In some embodiments, the water soluble cellulose ether may comprise methyl cellulose.

Methods of the invention employ treatment fluids that may be used as part of any subterranean operation. Such operations include, but are not limited to, drilling operations, lost circulation operations, stimulation operations, sand control operations, completion operations, acidizing operations, scale inhibiting operations, water-blocking operations, clay stabilizer operations, fracturing operations, frac and pack operations, gravel packing operations, wellbore strengthening operations, enhanced oil recovery operations, fluid diverting operations, and sag control operations. The methods and compositions of the present invention may be used in full-scale operations or pills. As used herein, a “pill” is a type of relatively small volume of specially prepared treatment fluid placed or circulated in the wellbore. In some embodiments, treatment fluids comprising thermally gelling polymers and solid-liquid phase temperature modifiers employed in methods of the invention may perform the function of controlling flow of formation fluids, controlling the flow of treatment fluid itself, controlling the flow of other treatment fluids, and combinations thereof.

Treatment fluids of the invention may be aqueous-based, oil-based, or combinations thereof. Thus, suitable base fluids in treatment fluids of the invention, for use in conjunction with various methods may include, but are not limited to, aqueous-based fluids, aqueous-miscible fluids, water-in-oil emulsions, or oil-in-water emulsions.

Aqueous base fluids suitable for use in the treatment fluids of the present invention may comprise fresh water, saltwater (e.g., water containing one or more salts dissolved therein), brine (e.g., saturated saltwater), seawater, or combinations thereof. Generally, the water may be from any source, provided that it does not contain components that might adversely affect the stability and/or performance of the treatment fluids of the present invention. In certain embodiments, the density of the aqueous base fluid can be adjusted, among other purposes, to provide additional particulate transport and suspension in the treatment fluids used in the methods of the present invention. In certain embodiments, the pH of the aqueous base fluid may be adjusted (e.g., by a buffer or other pH adjusting agent), among other purposes, to activate a cross-linking agent and/or to reduce the viscosity of the first treatment fluid (e.g., activate a breaker, deactivate a crosslinking agent). In these embodiments, the pH may be adjusted to a specific level, which may depend on, among other factors, the types of gelling agents, acids, and other additives included in the treatment fluid. One of ordinary skill in the art, with the benefit of this disclosure, will recognize when such density and/or pH adjustments are appropriate.

Suitable aqueous-based fluids may include fresh water, saltwater (e.g., water containing one or more salts dissolved therein), brine (e.g., saturated saltwater), seawater, and any combination thereof. Suitable aqueous-miscible fluids may include, but not be limited to, alcohols, e.g., methanol, ethanol, n-propanol, isopropanol, n-butanol, sec-butanol, isobutanol, and t-butanol; glycerins; glycols, e.g., polyglycols, propylene glycol, and ethylene glycol; polyglycol amines; polyols; any derivative thereof; any in combination with salts, e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate; any in combination with an aqueous-based fluid, and any combination thereof. Suitable water-in-oil emulsions, also known as invert emulsions, may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base treatment fluid, where the amount may range from any lower limit to any upper limit and encompass any subset therebetween. Examples of suitable invert emulsions include those disclosed in U.S. Pat. No. 5,905,061, U.S. Pat. No. 5,977,031, and U.S. Pat. No. 6,828,279, each of which is incorporated herein by reference. It should be noted that for water-in-oil and oil-in-water emulsions, any mixture of the above may be used including the water being and/or comprising an aqueous-miscible fluid. It is understood that the gelling agent may be selected to viscosify and gel only upon exposure of the treatment fluid to an aqueous in which it must dissolve, regardless of the timing of the exposure to an aqueous fluid. Thus, for example, non-aqueous fluids or water miscible anhydrous fluids may serve as carrier fluids for the solid gelling agents. Viscosification and/or gelling may then take place only when such anhydrous fluid systems are brought into contact with aqueous fluids in which the solid gelling agent can dissolve. In some embodiments, an aqueous solution of the gelling agents may be emulsified in an oil or an oleaginous fluid to form water-in-oil emulsions. In other embodiments, an oil can be emulsified into an aqueous solution of gelling agent to form oil-in-water emulsions.

Examples of suitable continuous mediums may include, but are not necessarily limited to, aqueous-based fluids, alcohols, glycerin, glycols, polyglycol amines, polyols, and any derivative thereof. Additionally, in some embodiments, the continuous medium may comprise a fluid selected from the group consisting of methanol, ethanol, n-propanol, isopropanol, n-butanol, sec-butanol, isobutanol, t-butanol, a mixture of methanol, ethanol, n-propanol, isopropanol, n-butanol, sec-butanol, isobutanol, or t-butanol and water, a mixture of ammonium sulfate, sodium sulfate, or potassium sulfate and water, a mixture of sodium chloride, potassium chloride, or calcium chloride and water, and combinations thereof. Optionally, the continuous medium comprises a fluid selected from the group consisting of ethanol, a mixture of t-butanol and water, and a mixture of ammonium sulfate and water. Mixtures of these may be suitable as well. Examples of suitable aqueous-based fluids may include, but are not necessarily limited to, fresh water, seawater, saltwater, and brines (e.g., saturated saltwaters). Examples of suitable brines may include, but are not necessarily limited to, heavy brines, monovalent brines, divalent brines, and trivalent brines that comprise a soluble salt like sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, potassium carbonate, any combination thereof, and any derivative thereof. Examples of suitable alcohols may include, but are not necessarily limited to, methanol, ethanol, propanol, iso-propanol, butanol, tert-butanol, and the like. Examples of suitable glycols may include, but are not necessarily limited to, polyglycols, propylene glycol, ethylene glycol, and the like.

A suitable oleaginous continuous phase for use in the present invention includes any oleaginous continuous phase fluid suitable for use in subterranean operations. By way of nonlimiting example, an oleaginous continuous phase may include an alkane, an olefin, an aromatic organic compound, a cyclic alkane, a paraffin, a diesel fluid, a mineral oil, a desulfurized hydrogenated kerosene, and any combination thereof. In some embodiments, the base treatment fluid may include an invert emulsion with an oleaginous continuous phase and an aqueous discontinuous phase. Suitable invert emulsions may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base treatment fluid, where the amount may range from any lower limit to any upper limit and encompass any subset therebetween.

In some embodiments, the treatment fluids for use in conjunction with the present invention may be foamed. In some embodiments, treatment fluids for use in conjunction with the present invention may comprise an aqueous base fluid, a gas, and a foaming agent.

Suitable gases for use in conjunction with the present invention may include, but are not limited to, nitrogen, carbon dioxide, air, methane, helium, argon, and any combination thereof. One skilled in the art, with the benefit of this disclosure, should understand the benefit of each gas. By way of nonlimiting example, carbon dioxide foams may have deeper well capability than nitrogen foams because carbon dioxide emulsions have greater density than nitrogen gas foams, so that the surface pumping pressure required to reach a corresponding depth is lower with carbon dioxide than with nitrogen. Moreover, the higher density may impart greater proppant transport capability, up to about 12 lb of proppant per gal of fracture fluid.

In some embodiments, the quality of the foamed treatment fluid downhole may range from a lower limit of about 5%, 10%, 25%, 40%, 50%, 60%, or 70% gas volume to an upper limit of about 99%, 95%, 90%, 80%, 75%, 60%, or 50% gas volume, and wherein the quality of the foamed treatment fluid may range from any lower limit to any upper limit and encompass any subset therebetween. Most preferably, the foamed treatment fluid may have a foam quality from about 85% to about 99%, or about 95% to about 98%.

Suitable foaming agents for use in conjunction with the present invention may include, but are not limited to, cationic foaming agents, anionic foaming agents, amphoteric, zwitterionic foaming agents, nonionic foaming agents, or any combination thereof. Nonlimiting examples of suitable foaming agents may include, but are not limited to, surfactants like betaines, sulfated or sulfonated alkoxylates, alkyl quarternary amines, alkoxylated linear alcohols, alkyl sulfonates, alkyl aryl sulfonates, C10-C20 alkyldiphenyl ether sulfonates, polyethylene glycols, ethers of alkylated phenol, sodium dodecylsulfate, alpha olefin sulfonates such as sodium dodecane sulfonate, trimethyl hexadecyl ammonium bromide, and the like, any derivative thereof, or any combination thereof. Foaming agents may be included in foamed treatment fluids at concentrations ranging typically from about 0.05% to about 2% of the liquid component by weight (e.g., from about 0.5 to about 20 gallons per 1000 gallons of liquid).

Treatment fluids of the invention may further comprise weighting agents, viscosifiers, emulsifiers, proppants, pH modifying agents, cementing compositions, lost circulation materials, corrosion inhibitors, other subterranean treatment fluid additives, and the like, depending on the function of the treatment fluid.

In some embodiments, the thermally gelling polymers comprise water soluble cellulose ethers. As used herein, “water-soluble” thermally gelling polymers comprise those polymers having a solubility in water of at least about 0.001 grams per milliliter (g/mL) or at least about 0.1% solubility at room temperature. As used herein, a “thermally gelling polymer” is a polymer exhibiting a temperature-dependent phase transition from liquid to solid phase at temperatures that may be encountered during various subterranean operations. Such transition temperatures may be proximal to the natural temperatures encountered downhole or may be temperatures that are achieved through routine cooling or heating of the formation during subterranean operations by an operator.

In some embodiments, water soluble ethers comprise those with a degree of substitution (DS) from about 1.3 to about 2.6. In some embodiments, water soluble cellulose ethers comprise one selected from the group consisting of methyl cellulose, methylhydroxyethyl cellulose, ethylcellulose, ethylhydroxyethyl cellulose, hydroxypropyl cellulose, hydroxypropylmethylcellulose and hydrophobically modified hydroxyethyl celluloses. In accordance with embodiments disclosed herein, the thermally gelling polymers may be advantageously a single-polymer system, however, this would not preclude the use of two, three, four, or more polymers to achieve similar results. Suitable structural characteristics and physical properties of cellulose ethers relevant to this invention are described in U.S. Pat. No. 5,462,742, which is incorporated herein by reference in its entirety.

In some embodiments, the amount of viscosifying polymer employed in methods of the invention may be in a range from about 0.1% to about 5% by weight of the fluid excluding the weight of any solid or gaseous additives, including any value in between and fractions thereof.

In some embodiments, the solid-liquid phase temperature modifier comprises a surfactant. In some such embodiments, the surfactant comprises one selected from the group consisting of anionic surfactants, cationic surfactants, and zwitterionic surfactants. In some embodiments, the solid-liquid phase temperature modifier may comprise a non-ionic surfactant. In some embodiments, a combination of two surfactants may be used in methods of the invention. For example, two anionic surfactants or two cationic surfactants, or two zwitterionic surfactants, or a combination of an anionic surfactant and zwitterionic surfactant, or a combination of a cationic surfactant and a zwitterionic surfactant, or a combination of an anionic surfactant and a cationic surfactant. In some embodiments, a combination of three or more surfactants may also be employed.

Examples of anionic surfactants suitable for use in methods disclosed herein include, without limitation, alkali salts of acids, alkali salts of fatty acids, alkaline salts of acids, sodium salts of acid, sodium salts of fatty acid, alkyl sulphates, alkyl ethoxylate, sulphates, sulfonates, sufosuccinates, soaps, or a combination thereof. In an embodiment, the anionic surfactant comprises sodium oleate, sodium stearate, sodium dodecylbenzenesulfonate, sodium myristate, sodium laurate, sodium decanoate, sodium caprylate, sodium cetyl sulfate, sodium myristyl sulfate, sodium lauryl sulfate, sodium decyl sulfate, sodium dodecyl sulfate, sodium octyl sulfate, sodium salt of sulfonated naphthlene formaldehyde condensate, or sulfonated lignin, sodium dioctyl sulfosuccinate, or a combination thereof.

In some embodiments, the weight ratio of cellulose ether to anionic surfactants may be in a range from about 2:1 to about 25:1, including any ratio therebetween. It is to be understood that the exact ratio may depend on the extent of desired phase transition temperature alteration, as well as nature of the cellulose ether, the surfactant and dissolved solute content, for example dissolved salt content, of the fluid.

Examples of cationic surfactants suitable for use in methods disclosed herein include, without limitation, quaternary ammonium salts, ethoxylated quaternary ammonium salts, amine oxides, or a combination thereof. In an embodiment, the cationic surfactant comprises stearyltrimethylammonium chloride, cetyltrimethylammonium tosylate, cetyltrimethylammonium chloride, cetyltrimethylammonium bromide, myristyltrimethylammonium chloride, myristyltrimethylammonium bromide, dodecyltrimethylammonium chloride, dodecyltrimethylammonium bromide, decyltrimethylammonium chloride, decyltrimethylammonium bromide, octyltrimethylammonium chloride, erucyl bis-(hydroxy ethyl)methylammonium chloride, erucyltrimethylammonium chloride, or a combination thereof.

In some embodiments, the weight ratio of cellulose ether to cationic surfactants may be present in a range from about 2:1 to about 25:1, including any ratio therebetween. It is to be understood that the exact ratio may depend on the extent of desired phase transition temperature alteration, as well as the nature of the cellulose ether, the surfactant and dissolved solute content, for example dissolved salt content, of the fluid.

Examples of zwitterionic surfactants suitable for use in methods disclosed herein include, without limitation, alkyl amine oxides, alkyl betaines, alkyl amidopropyl betaine, alkyl sulfobetaines, alkyl sultaines, dihydroxyl alkyl glycinate, alkyl ampho acetate, phospholipids, alkyl aminopropionic acids, alkyl imino monopropionic acids, alkyl imino dipropionic acids, or combinations thereof.

In some embodiments, the weight ratio of cellulose ether to zwitterionic surfactants may be present in a range from about 2:1 to about 25:1. It is to be understood that the exact ratio may depend on the extent of desired phase transition temperature alteration, as well as the nature of the cellulose ether, the surfactant and dissolved solute content, for example dissolved salt content, of the fluid.

In some embodiments, the zwitterionic surfactant comprises an amine oxide. Amine oxides, also termed amine N-oxides or N-oxides, are chemical compounds that comprise the functional group R₃N⁺—O⁻ where R may be an alkyl moiety having from 1 to 20 carbon atoms. The term amine oxide herein is meant to comprise oxides of tertiary amines including nitrogen containing aromatic compounds, analogous primary or secondary amines, derivatives thereof, or combinations thereof. Examples of amine oxides suitable for use in methods disclosed herein include, without limitation, decylamine oxide, dodecylamine oxide, tetradecylamine oxide, or combinations thereof.

In some embodiments, the zwitterionic surfactant comprises a betaine. Betaines are neutral chemical compounds comprising positively charged cationic functional groups and an equal number of negatively charged functional groups that may not be adjacent to the cationic site so that the whole molecule is electrically neutral. For example, a betaine may comprise an onium ion (e.g., ammonium, phosphonium) and a carboxylate group. Examples of betaines suitable for use in methods disclosed herein include, without limitation, laurylamidopropyl betaine, decyl betaine, dodecyl betaine, or combinations thereof.

In some embodiments, the zwitterionic surfactant comprises a phospholipid. Phospholipids are similar in structure to tri-glycerides with the exception that the first hydroxyl of the glycerine molecule has a polar phosphate containing group in place of the fatty acid. The hydrocarbon chain of the phospholipid is hydrophobic, while the charges on the phosphate groups make that portion of the molecule hydrophilic, resulting in an amphiphilic molecule. Examples of phospholipids suitable for use in methods disclosed herein include, without limitation, lecithin, phosphatidyl choline, derivatives thereof, or combinations thereof.

In some embodiments, the surfactant is a nonionic surfactant. A nonionic surfactant generally has an uncharged hydrophilic head and a hydrophobic tail comprising a carbon chain. A non-ionic surfactant suitable for use in methods disclosed herein may have carbon chain having a length of from about 8 to about 24, alternatively from about 8 to about 18, alternatively from about 12 to about 22, alternatively from about 18 to about 24. Examples of nonionic surfactants suitable for use in methods disclosed herein include, without limitation, linear alcohol ethoxylates, polyoxyethylene alkylphenol ethoxylates, polyoxyethylene alcohol ethoxylates, polyoxyethylene esters of fatty acids, polyoxyethylene mercaptans, polyoxyethylene alkylamines, polyol ester surfactants, or a combination thereof.

In some embodiments, a weight ratio of cellulose ether to nonionic surfactants may be present in a range from about 2:1 to about 25:1. It is to be understood that the exact ratio may depend on the extent of desired phase transition temperature alteration, as well as the nature of the cellulose ether, the surfactant and dissolved solute content, for example dissolved salt content, of the fluid.

In some embodiments, the phase transition temperature modifier may be an organic salt that is not a surfactant. Such molecules may be differentiated from surfactants in general by their inability to form micelles in aqueous fluids. Like surfactants, they contain a hydrophobic portion and a hydrophilic ionically charged portion. However, the carbon length of the hydrophobic portion is not sufficiently long enough to self-aggregate into micelles like surfactants. In some embodiments, the organic salt may be monomeric or polymeric. In some embodiments, the organic salts are not surface active, that is they do not significantly lower the surface tension of water, or the interfacial tension between water and an immiscible organic liquid. In some embodiments, the charge on the organic salt may be due to a sulfonate group, a carboxylate group, or a phosphonate group. Examples of polymeric organic salts include, without limitation, lignosulfonates with high levels of sulfonation and sodium salts of sulfonated naphthalene formaldehyde condensates. An example of a commercially available lignosulfonate is HR-5 available from Halliburton (Duncan, Okla.). An example of a commercially available sodium salt of sulfonated naphthalene formaldehyde condensate is CFR-6 also available from Halliburton (Duncan, Okla.). In some embodiments, the organic salt may be a hydrotrope. A hydrotrope is defined as an organic material that improves solubility of hydrophobic substances in water. Examples of suitable hydrotropes include alkali and alkaline earth metal salts of naphthalene sulfonic acid, toluene sulfonic acid, and cumene sulfonic acid. The weight ratio of cellulose ether to hydrotrope may be in a range from about 20:1 to about 1:10, including any ratio therebetween.

In some embodiments, treatment fluids employed in methods of the invention further comprise a cellulose ether that has been pretreated with a “cellulose modifier” prior to use. In some such embodiments, the viscosifying polymer may comprise a water soluble cellulose. As used herein, a “cellulose modifier” is a chemical agent capable of forming a covalent bond with the water soluble celluloses. In particular embodiments, the cellulose modifier comprises an organic carbonate. In some such embodiments, the cellulose modifier comprises an organic carbonate comprising glycerine carbonate. Examples of other suitable organic carbonates include ethyelene carbonate, propylene carbonate, butylene carbonate, and diethyl carbonate.

Without being bound by theory, it has been indicated that the cellulose modifier may form a covalent bond to the water soluble cellulose, but does not necessarily provide a crosslink, or in some embodiments, only a low degree of crosslinking. The modification of the water soluble celluloses may provide a resultant product that reduces the amount of viscosifying polymer needed in gel system for subterranean operations to achieve desired viscosity values. For example, it may reduce the amount of viscosifying polymer by about 2 to about 10 times.

In some embodiments, the cellulose modifier is a transesterification agent. As used herein, a “transesterification agent” is an organic compound containing at least one ester functional group capable of undergoing conventional transesterification reactions with hydroxyl groups in a water soluble cellulose. As an example of the requirements for being a transesterification agent, the chemical functionality for the reaction must be sufficiently sterically unhindered for the chemical reaction with the water soluble cellulose.

Even though the organic compounds being reacted with water soluble celluloses are referred to as “transesterification agents,” it should be noted that the term does not necessarily imply that the reactions between the transesterification agents and water soluble celluloses are necessarily transesterification reactions between the alcohol groups of the water soluble celluloses and the ester groups of the transesterification agents. While such reactions are presently believed to be possible, no conventional methods were employed in the process to encourage and promote transesterification reactions. For example, there was no addition of acid catalysts, either of Lewis acid or Bronsted acid types, or weakly basic catalysts such as triphenyphosphine, and no techniques such as azeotropic removal of alcohol by-products.

In some embodiments, a transesterification agent may contain at least two ester (—COOR¹) functional groups, or at least one carbonate ester (R²OC(O)OR³) group, wherein R¹, R² and R³ are alkyl or alkylene groups, which can be the same or different.

An exemplary transesterification agent is a non-polymeric organic carbonate. Non-polymeric organic carbonates are commercially available, and some are marketed as environmentally preferred and cost-effective solvents. The organic carbonate group may be part of a cyclic structure or may be an acyclic carbonate. Examples of non-polymeric cyclic organic carbonates that are capable of transesterification reactions with a water soluble cellulose include those described herein above, namely, ethylene carbonate, propylene carbonate, glycerine carbonate (also known as glyceryl carbonate), and butylene carbonate, and an example of a non-polymeric acyclic carbonate is diethyl carbonate.

Suitable carbonates may be liquids at room temperature (about 25° C.) or low melting solids. Suitable low melting solids are those with a melting temperature that is lower than the combining temperature when reacted with a water soluble cellulose. Ethylene carbonate is a solid (with a low melting point of 37-39° C.) and the other carbonates listed above are liquids at room temperature (about 25° C.).

The carbonate functionality is chemically reactive in the presence of suitable functional groups, for example, alcohol, thiols, carboxylic acids, carboxylic acid anhydrides, and amine groups. However, the type of products formed between compounds containing above-listed functional groups and an organic carbonate may depend on the reaction conditions. For example, in the presence of a base such as sodium hydroxide or a quaternary ammonium halide under aqueous conditions, the reaction between a compound containing alcohol (hydroxyl groups) and an organic carbonate, for example ethylene carbonate, is a hydroxyethylation reaction, and not a transesterification reaction. See, for example, U.S. Pat. No. 4,474,951, which is incorporated herein by reference in its entirety; see also, Indian Journal of Chemistry, vol 9, pages 1081-1082 (1971). The resulting hydroxyethylated products show enhanced water solubilities. For example, insoluble cellulose can be hydroxylated in this manner to form water-soluble hydroxyethyl cellulose. On the other hand, using an acidic (Lewis or Bronsted type) or weakly basic catalysts, the reaction between the same compounds is a transesterification reaction, wherein either one or both the ester functionalities of the organic carbonate can undergo transesterification reactions. Such reactions typically employ solvents. Reactions of organic carbonates, particularly cyclic alkylene carbonates are described in a review article by John H Clements, in Ind. Eng. Chem. Res, 2003, 42, 663-674 and JEFFSOL Alkylene Carbonates (technical Bulletin); Huntsman Petrochemical Corporation Austin, Tex., 2001, each of which is incorporated herein by reference in its entirety.

Based on these studies and principles of organic chemistry, it has been indicated that other carbonate analogues such as cyclic carbamates and imidazolidone, and organic esters may provide similar benefits in the modification of water soluble celluloses as do the organic carbonates, and hence are contemplated to fall under the scope of the present invention.

Suitable transesterification agents containing at least two ester functional groups include, without limitation, those that contain 0 to 4 carbons between the ester functional groups, as in R⁴OOC—(CXY)—COOR⁵, wherein R⁴ and R⁵ are alkyl or alkylene groups and X and Y are independently hydrogen, alcohol, or ether groups. Examples of suitable ester molecules include diethyl tartarate, trimethyl citrate, diethyl succinate, diethyl malonate, diethyl dimethyl adipate, and diethyl oxalate.

Examples of transesterification agents containing a single ester group include ethylacetate, ethyl benzoate, and butyl acetate. It has been indicated that when monoesters are used, the modified water soluble celluloses may be rendered insoluble without a molecular weight increase, whereas use of reagents containing at least two ester groups may insolubilize the water soluble celluloses while increasing its molecular weight.

In the following laboratory examples, a water soluble cellulose in solid state was treated as follows. The water soluble cellulose in a granular form was spread out in a thin layer. The organic carbonate in liquid form was added dropwise by a pipette with vigorous intermittent shaking of the solid during the addition in order to expose fresh solid surface and to form a substantially homogeneous liquid coating of the organic carbonate on the solid water soluble cellulose. The organic carbonate or other transesterification agent may be selected for being in liquid form at room temperature and one atmosphere pressure or being a low melting solid which having a melting point below the reaction temperatures. In an embodiment, a mixture of two or more organic carbonates may be used to modify the water soluble cellulose or its derivatives. In the cases where the organic carbonate is a solid at room temperature, for example, ethylene carbonate, the solid carbonate was finely ground to greater than 40 mesh size prior to mixing with solid water soluble cellulose, and the resulting mixture was mixed thoroughly by shaking.

As used herein, “substantially dry conditions” means in the presence of less than 10% by weight water relative to the water soluble cellulose. If any water or moisture is present, the water is at a pH of 8 or less. More preferably, any water is less than 5% by weight relative to the water soluble cellulose. Most preferably, the water soluble cellulose is essentially dry, having less than 1% by weight water or moisture.

No acidic or mild base catalysts, or basic materials, such as sodium hydroxide, are required. No solvents are needed during the chemical reaction phase. More preferably, excluded from the reaction mixture are chemicals containing reactive hydrogen atoms, e.g., those that contain free hydroxyl, mercapto, carboxylic acid, carboxylic acid anhydride, imido, and amido groups. In addition, non-aqueous solvents may be preferably avoided, except as an option in the case of an organic carbonate that is a solid at the reaction temperature, which may require a small amount of an organic solvent to dissolve or liquefy the carbonate. The solvent used to dissolve a solid carbonate preferably does not contain the reactive groups described above, and may be removed in a step prior to the reaction phase, for example, prior to heating the mixture to the desired reaction temperature. This avoids undesired chemical reactions that would otherwise occur (or at least prematurely) with chemicals containing active hydrogen atoms, especially under high pH conditions (that is, pH greater than 8). Without being bound by theory, it has been indicated that this helps achieve the characteristics of the modified water soluble cellulose, which provides rheological and other characteristics useful in well treatments. In addition, avoiding the use of solvents in the production of modified water soluble cellulose is economically advantageous and avoids introducing undesirable solvents into a well treatment fluid and, ultimately, into a well. Furthermore, obtaining the final reaction product directly as a solid at the end of the production phase saves cost in removing and disposing of solvents if the reactions were to be done in solvents such as water or organic solvents.

The reaction time at temperature may be selected to be sufficient for reaction to proceed to substantial completion. Preferably, the solid water soluble cellulose and organic carbonate are heated to promote chemical reaction. The heating should not exceed the caramelization or decomposition temperature of the water soluble cellulose, whichever is lower. Most preferably, the water soluble cellulose and organic carbonate are heated to within a temperature range from about 40° C. to about 160° C., provided the heating is less than the caramelization temperature of the polysaccharide. Similarly, the reaction may be conducted at a temperature that is at least above the freezing/melting temperature of the organic carbonate. It is preferred that the reaction is conducted in a roller oven so that reaction mixture is rolled during the reaction to ensure homogeneous blending of the reaction components. The reaction can be conducted at any convenient pressure, provided the organic carbonate remains in liquid form at the reaction temperature. In the following examples, the solid water soluble cellulose and organic carbonate were heated to about 82° C. for about 6 to 24 hours. The completion of reaction can be monitored by techniques such as thermogravimetric analysis (“TGA”).

Preferably, the granular form of the solid polysaccharide has a mesh size in a range from about 80 to about 200. In case the polysaccharide has significant amounts of moisture adsorbed or retained, a dehydration step to reduce the moisture content below 10% by weight of the polysaccharide and most preferably below 1% by weight of the polysaccharide can be included prior to exposure to the organic carbonate. This process combines the solid polysaccharide and the organic carbonate, provides sufficient contact for chemical reaction, and provides a solid, granular product. Thus, the modified water soluble cellulose may be preferably in a free-flowing, solid state after treatment with the organic carbonate.

For a commercial application, the combination may be preferably more uniform or the materials may be mixed, for example, by spray coating the liquid carbonate on to the polysaccharide solid spread on a conveyor belt. In a commercial application, the method of treatment presently indicated to be as simple as hot-drum rolling of the water soluble cellulose and the organic carbonate mix for a specific duration. In the case of solid carbonate, the carbonate may be melted and spray coated on the water soluble cellulose solid. Alternatively, the pulverized solid carbonate and solid water soluble cellulose may be simply dry blended. Alternatively, if not in liquid form or if otherwise desired, the organic carbonate can be dissolved in an organic solvent. Preferably, only a sufficient amount of organic solvent would be used to dissolve the organic carbonate to provide a liquid form at the desired reaction temperature and pressure. But most preferably, the water soluble cellulose and the organic carbonate are combined without any solvent for either the water soluble cellulose or the organic carbonate.

It has been indicated that solid water soluble cellulose and related derivatives can be reacted with organic carbonates forming products that, when added to water: (1) have increased viscosifying efficiency, i.e., higher viscosities at reduced concentrations; or (2) are insolubilized at normal temperature ranges at which unmodified precursors hydrate fully and dissolve; or (3) both properties.

The chemical modification of solid water soluble cellulose with organic carbonates may lead, in some cases, to increase in viscosity, while retaining hydration behavior similar to that for unmodified water soluble cellulose. In some cases, the chemical modification resulted in severe loss in hydratability at room temperature.

In addition, it has also been indicated that the polymers with severely limited hydratability due to reactions with organic carbonates can be hydrated in a controlled manner at higher temperatures or higher pH values. In general, it has been indicated that treatment of helical (double helix or triple helix) water soluble cellulose in solid sate with organic carbonates increases the viscosity of polymer solutions. The hydratability of these modified water soluble cellulose depended not only on the organic carbonate used, but also on the water soluble cellulose.

In general, it has also been indicated that non-helical polymers exhibited delayed hydration. In the case of helical polymers, ethylene carbonate treatment also delayed hydration rate. Use of combination of suitable organic carbonates is expected to provide products with desired combination of viscosification efficiency and hydration properties.

Increased product viscosities for modified water soluble cellulose suggests increased molecular weight of the modified water soluble cellulose when compared to the unmodified starting water soluble cellulose. Without being limited by theory, it has been indicated that the organic carbonates may participate in intramolecular transesterification reactions with alcohol groups on adjacent carbons (for example C2 and C3 carbons of hexose rings to form intra-chain carbonate groups, or between the alcohol groups on two different polymer chains to form an inter-chain carbonate group, or most likely both). The inter-chain carbonate formation is akin to cross-linking leading to increased molecular weights, and thus increased viscosities. The intra-chain carbonate formation is likely to decrease the solubility of modified water soluble cellulose due to decreased number of free hydroxyl groups, which results in decreased ability to hydrogen bond with water. The ratio of intra- to inter-chain carbonate formations appears to be dependent on the water soluble cellulose monomer structure, polymer chain conformation in solid state, as well as the carbonate structure. Similar considerations can be applied to the reactions with transesterification agents that contain at least two discrete ester groups. It has been indicated that by using an organic monoester, the hydratability and solubility of water soluble cellulose and their derivatives may be decreased without increasing the polymer molecular weight, whereas using organic ester with at least two or more ester functionalities, the product hydratability, solubility may be decreased, and/or the viscosification efficiency may be increased. From the reduced hydratability and solubility of modified water soluble cellulose from reactions with organic carbonates, it has been indicated that the reactions likely do not proceed via hydroxyethylation because hydroxyethylated water soluble cellulose tend to show enhanced solubilities, contrary to the observed lower solubilities in many cases. It has also been indicated that other carbonate analogues such as cyclic carbamates and imidazolidone may provide similar benefits.

Methods of the invention employing the treatment fluids described herein about may be used in any subterranean application where control of formation permeability is indicated. For example, methods of the invention may provide the treatment fluids described herein in an operation to plug a thief zone.

In some embodiments, methods of the invention employ the treatment fluids described herein to divert fluids. For example, the treatment fluids may allow diversion of a treatment fluid away from a first portion of a subterranean formation to a second portion of a subterranean formation. Thus, in some embodiments methods of the invention comprise providing a first treatment fluid comprising an organic carbonate-modified water soluble cellulose ether, placing the first treatment fluid in a first portion of a subterranean formation penetrated by a wellbore, allowing first treatment fluid to viscosify and/or gel in place and placing a second treatment fluid in the wellbore, wherein the second treatment fluid is diverted away from the first portion of the subterranean formation. Such methods are expected to be useful in improving the sweep efficiency in enhanced hydrocarbon recovery using water or polymer floods, and for improving production rates by matrix acidizing.

In some embodiments, methods of the invention employ the treatment fluids disclosed herein in fluid loss control applications. For example, in some embodiments, methods of the invention include providing a treatment fluid comprising an organic carbonate-modified water soluble cellulose ether, and placing the treatment fluid in a subterranean formation penetrated by a wellbore to provide fluid loss control. In some such embodiments, the operation may be conducted with the use of thermally gelling polymers and solid-liquid phase transition temperature modifiers in pill form. In some embodiments, the fluid loss methods may include removing the gel after fluid loss control is no longer required by, for example, cooling the formation to below the solid-liquid phase transition of the polymer.

In some embodiments, any of the aforementioned subterranean operations may include during the method a step further comprising cooling the subterranean formation prior to placing the treatment fluid in the subterranean formation. In some such embodiments, the cooling may be performed selectively in a portion of the formation where the treatment fluid is to be pumped and the desired transition from liquid to gel form is desired. In some such embodiments, after cooling the targeted portion of the formation, the treatment fluid may be introduced to form the solid gel form to provide reduced formation permeability at that portion of the formation.

In some embodiments, methods of the invention may further comprise allowing the formation to warm to its inherent temperature after placing the treatment fluid in the subterranean formation. For example, this may allow the solid form of the gel to transition back to liquid phase at the end of an operation involving use of cooler treatment fluids, facilitating clean out and restoring the permeability of the formation. Thus, allowing the temperature to warm may be used to complete gel clean out. In some embodiments, the formation may be warmed to above the inherent temperature of the formation to assist in clean out. In still further embodiments, a secondary solid-liquid phase temperature modifier may be injected as part of clean out operations when formation permeability is ready to be restored.

In some embodiments, methods of the invention comprise providing a treatment fluid comprising a glycerine carbonate-modified water soluble cellulose ether, and placing the treatment fluid in a subterranean formation penetrated by a wellbore. In some such embodiments, the water soluble cellulose ether comprises methyl cellulose. Also in some such embodiments, the methods may further comprise providing the treatment fluid with a solid-liquid phase transition temperature modifier comprising a surfactant, the surfactant comprises one selected from the group consisting of anionic surfactants, cationic surfactants, and zwitterionic surfactants, as described herein above. In other embodiments, the methods may further comprise providing the treatment fluid with an organic salt that is not a surfactant, as described herein above. In methods employing glycerine carbonate, the glycerine carbonate (GC) may be covalently bonded to the water soluble cellulose ethers in a step prior to the use of the cellulose ether in well bore treatment fluids. In addition to shifting the liquid-solid phase transition temperature, a reduced amount of the resultant GC-modified water soluble cellulose ether may be employed.

In some embodiments, methods of the invention comprise providing a treatment fluid comprising an organic carbonate-modified water soluble cellulose ether, and placing the treatment fluid in a subterranean formation penetrated by a wellbore to reduce water influx into the wellbore. In some such embodiments, the resultant gel may be held in place for a duration of time of the entire production lifetime of the wellbore.

To facilitate a better understanding of the present invention, the following examples of preferred or representative embodiments are given. In no way should the following examples be read to limit, or to define, the scope of the invention.

### EXAMPLES

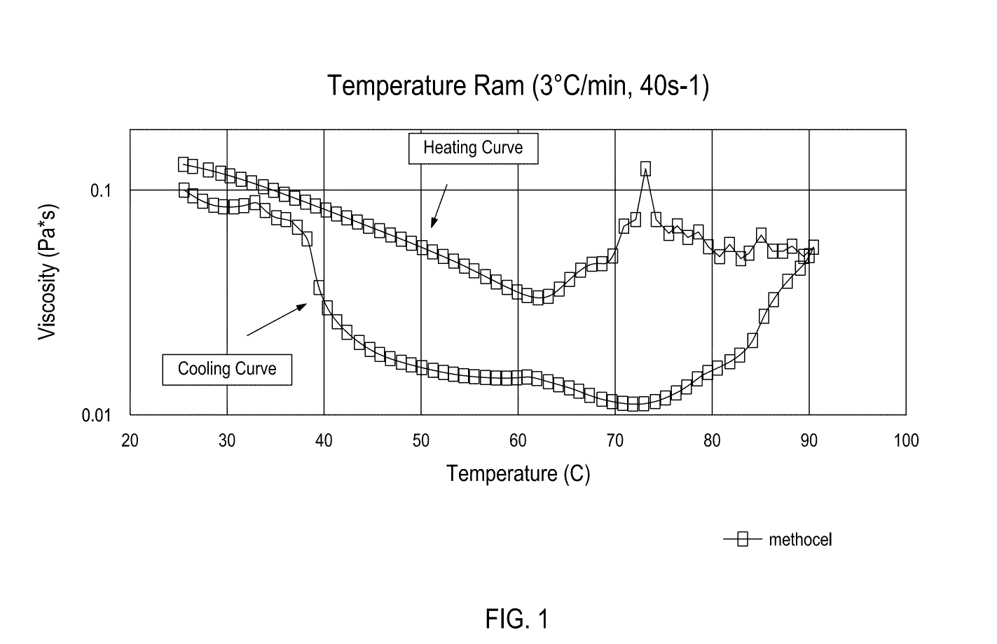

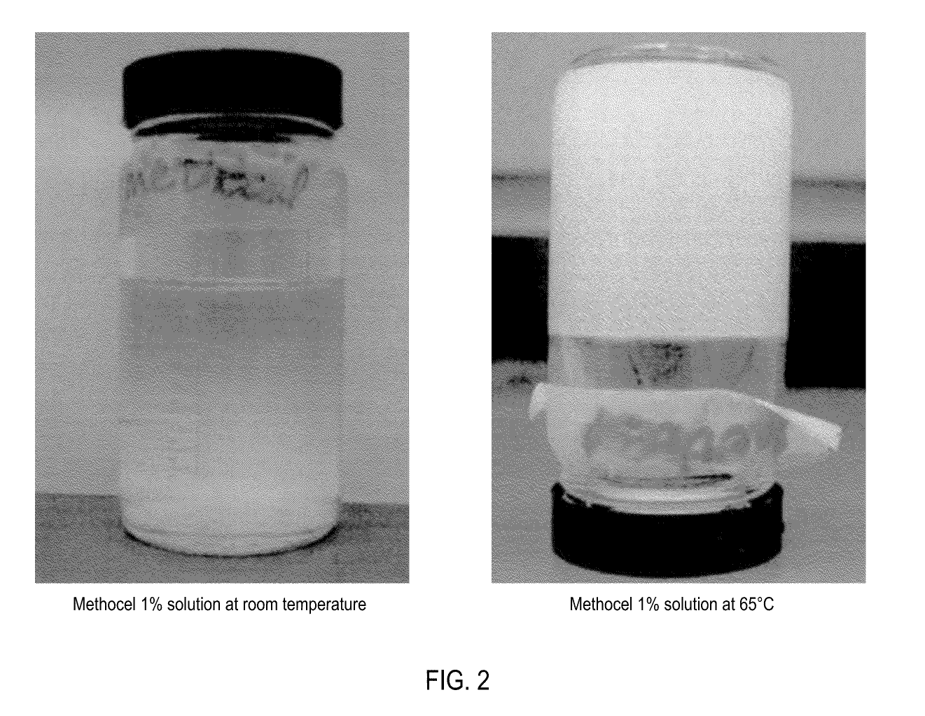

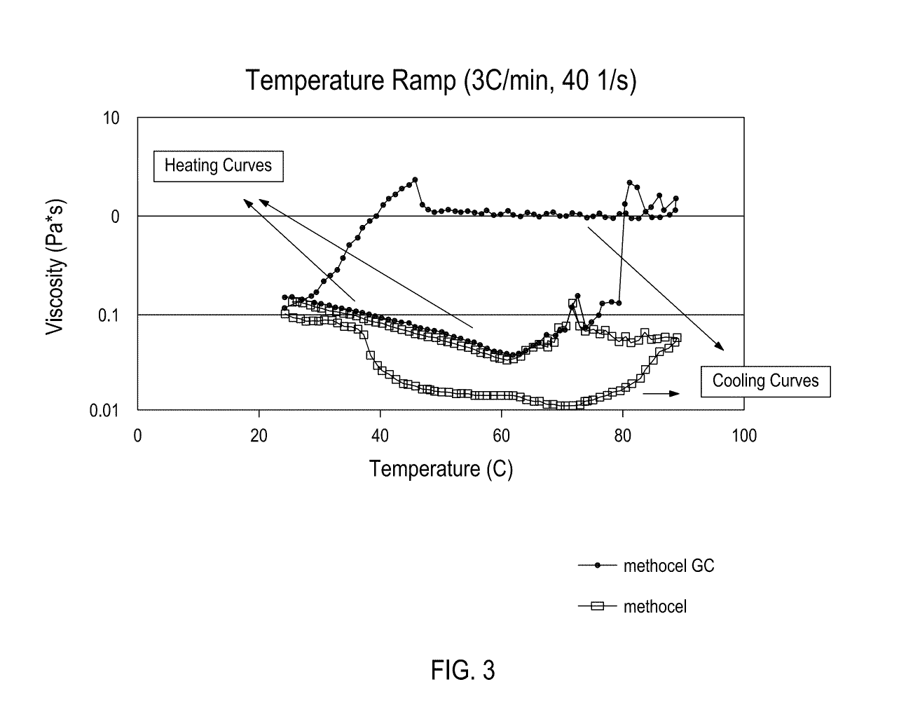

In conjunction with the FIGS. 1-6 provided in this Example, the thermal gellation and its reversibility upon cooling was measured by visual observation, as well as by rheological measurements. The steady shear rheological measurements were made by heating a solution of METHOCEL® at a shear rate of 40 sec⁻¹ and a heating rate of 3° C./minute. Static gel strengths were measured by oscillatory measurements by measuring elastic and loss moduli at a frequency of 1 Hz while heating the sample at 3° C./minute. The viscosity for 1% solution of METHOCEL® in tap water is shown in FIG. 1 and photographs of the solution and gelled METHOCEL® above its solid-liquid phase transition temperature are shown in FIG. 2. The sharply increased viscosity of the fluid above the phase transition temperature under steady shear conditions is evident in FIG. 1. FIG. 2 shows that the flowable polymer fluid becomes non-flowable, stiff gel above its solid-liquid phase transition temperature. The effect on viscosity of modifying METHOCEL® by reacting it with glycerine carbonate in the solid state according to known procedures as described in U.S. patent applications 20120090848 and 20120090846, each incorporated herein by reference in its entirety, is shown in FIG. 3, which also compares the corresponding viscosification behavior for the parent unmodified polymer. The steady shear fluid viscosities increased significantly with glycerine carbonate modification, thereby allowing reduction in polymer concentration to achieve a desired solution viscosity.

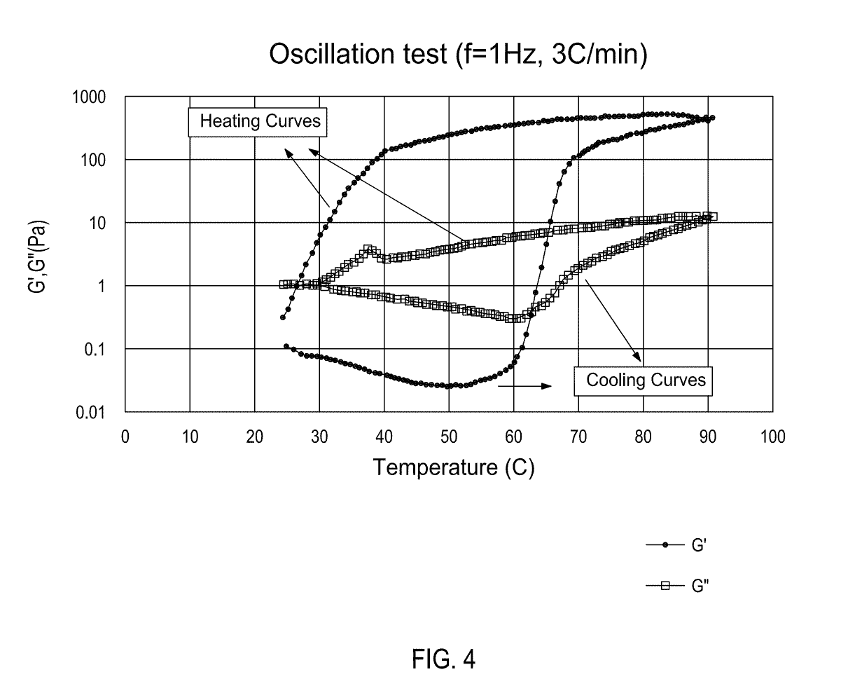

For operations that require reduction in permeability, the strength of the gel under static conditions is generally more indicative of applicability than that under shear. The reflection of gel strength under static conditions was measured by probing the gel structure under oscillatory conditions at a frequency of 1 Hz. The results for glycerine modified METHOCEL® are shown in FIG. 4. G′ values of approximately 500 Pa compares well to other known gel systems such as H2Zero gel (Halliburton, Duncan Okla.). This indicates that the gels of the invention are suitable for blocking production of water, preventing fluid loss, or are useful in fluid diversion operations.

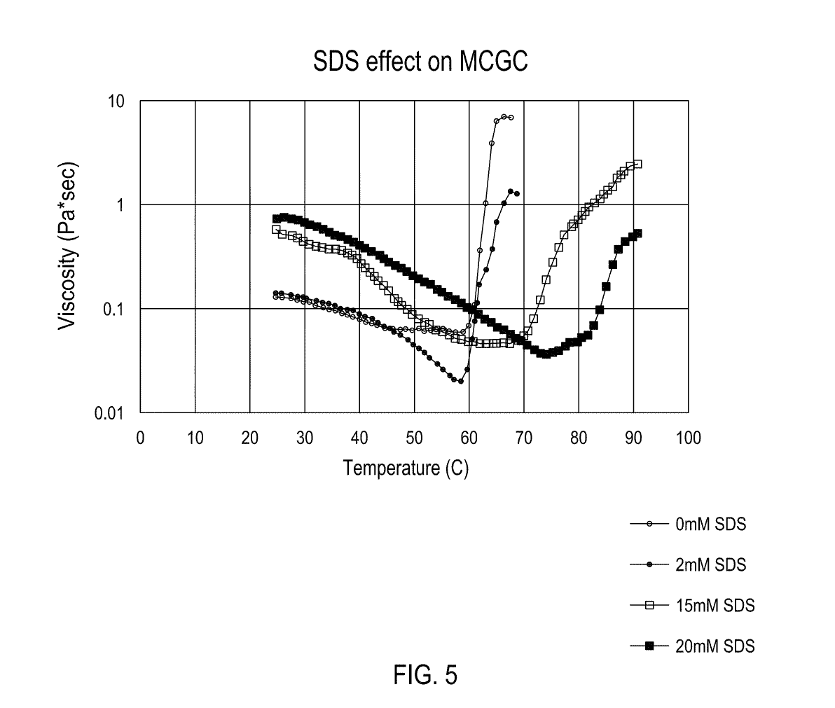

The ability to modify gellation temperature of methylcellulose by the addition of a surfactant was demonstrated by the addition of sodium dodecyl sulfate (SDS) at different concentrations to 1% solutions of glycerin carbonate modified METHOCEL® with the results shown in FIG. 5. The results indicate that the gellation temperature can be increased from 60° C. to 80° C. by the addition of increasing amounts of SDS.

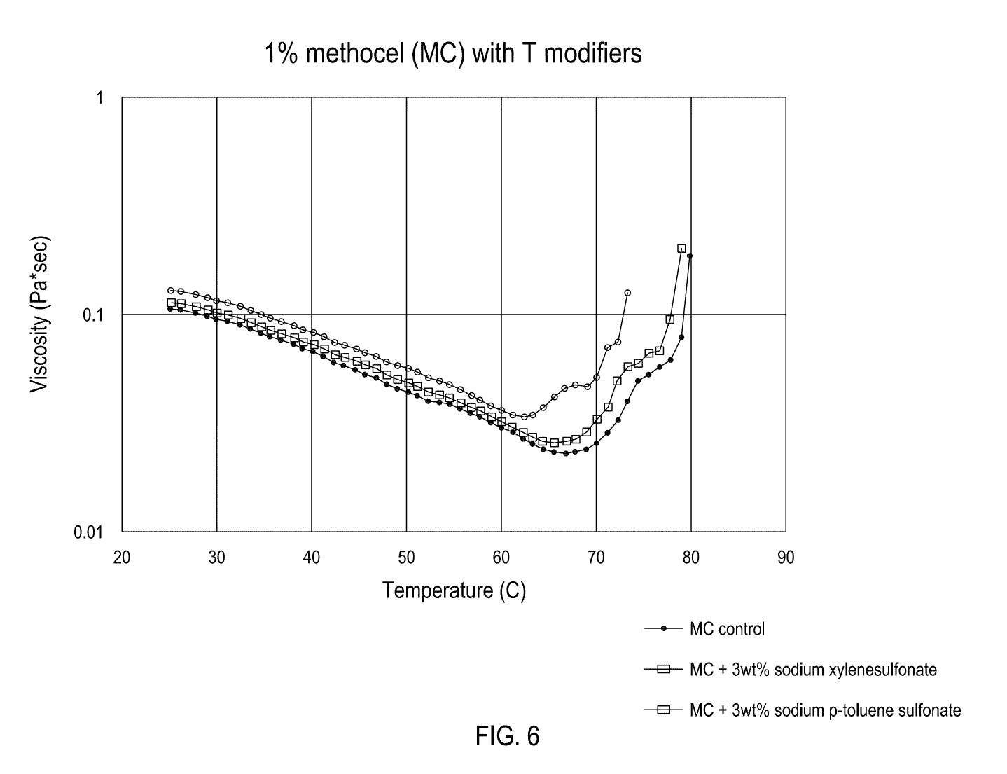

The ability to modify gellation temperature of methylcellulose by the addition of organic salts was demonstrated by the addition of sodium p-toluene sulfonate and sodium xylene sulfonate at 3% concentration to 1% solutions of METHOCEL® with the results shown in FIG. 6. The results indicate that the gellation temperature can be increased from about 61° C. to 67° C. by the addition of the organic salts.

In practice in the field, the polymer solution may be injected into matrix permeability at temperatures lower than the gellation temperature, and then the temperature allowed to increase to formation temperature which by suitable choice of fluid composition may be designed to be higher than the gellation temperature of the fluid. Then, at the formation temperature, the fluid may become a stiff gel and resist the flow of formation or wellbore fluid into or out of the wellbore.

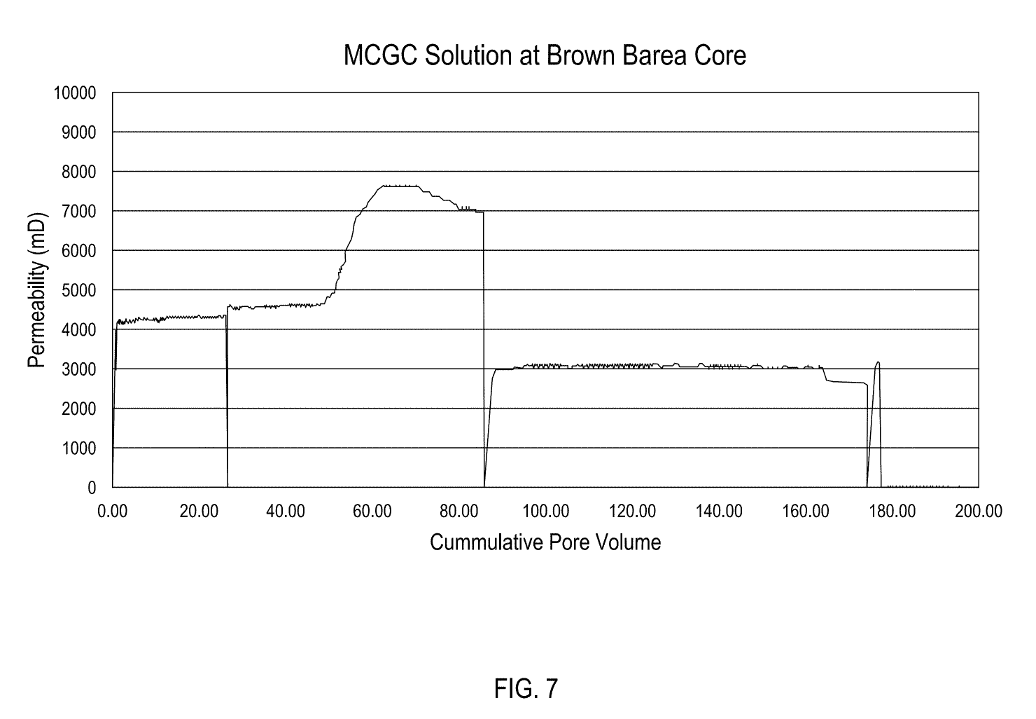

The ability of the viscosifying polymer solutions to reduce formation permeability was demonstrated by performing core flow tests in which a Brown Berea core was treated with two (2) pore volumes of METHOCEL® solution at a temperature of 130° F. in API brine. The core assembly was then heated up to 170° F. The permeability of the treated core to API brine was measured. The linear flow test results are shown in FIG. 7. The results indicate that the initial API brine permeability before polymer treatment was 3060.7 mD at 170° F. The core assembly was then held at this temperature for 48 hours to equilibrate temperature to allow the polymer treatment to gel. The average permeability of the core plug after introducing the METHOCEL® solution was reduced to 8.09 mD. Thus, the core flow studies indicate a reduction in permeability of 99.7%. This is a substantial improvement relative to conventional crosslinked systems. Moreover, in applications requiring temporary permeability reductions, clean out is more readily achieved relative to conventional gel systems by way of simply altering formation temperatures to break up the gel.

Therefore, the present invention is well adapted to attain the ends and advantages mentioned, as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
providing a treatment fluid comprising a viscosifying polymer and a solid-liquid phase transition temperature modifier; and
placing the treatment fluid in a subterranean formation penetrated by a wellbore
wherein the solid-liquid phase transition temperature modifier is added in an amount to modulate the gelling temperature of the viscosifying polymer to a target temperature.

2. The method of claim 1, wherein the viscosifying polymer comprises a water soluble cellulose ether.

3. The method of claim 2, wherein the water soluble cellulose ether comprises methyl cellulose, ethylhydroxyethyl cellulose, hydroxypropyl cellulose and hydrophobically modified hydroxyethyl celluloses.

4. The method of claim 1, wherein the solid-liquid phase transition temperature modifier comprises a surfactant.

5. The method of claim 4, wherein the surfactant comprises one selected from the group consisting of anionic surfactants, cationic surfactants, and zwitterionic surfactants.

6. The method of claim 1, wherein the solid-liquid phase transition temperature modifier comprises a non-surface active organic salt.

7. The method of claim 1, wherein the treatment fluid further comprises a cellulose modifier.

8. The method of claim 7, wherein the cellulose modifier comprises an organic carbonate.

9. The method of claim 8, wherein the organic carbonate comprises glycerine carbonate.

10. The method of claim 1, wherein the treatment fluid is used to control formation permeability.

11. The method of claim 1, wherein the treatment fluid is used to plug a thief zone.

12. The method of claim 1, wherein the treatment fluid is used to divert fluids.

13. The method of claim 1, wherein the treatment fluid is used for fluid loss control.

14. The method of claim 1, further comprising cooling the subterranean formation prior to placing the treatment fluid in the subterranean formation.

15. The method of claim 14, further comprising allowing the formation to warm to its inherent temperature after placing the treatment fluid in the subterranean formation.

16. A method comprising:
providing a treatment fluid comprising a glycerine carbonate-modified water soluble cellulose ether; and
placing the treatment fluid in a subterranean formation penetrated by a wellbore.

17. The method of claim 16, wherein the water soluble cellulose ether comprises methyl cellulose.

18. The method of claim 16, further comprising a solid-liquid phase temperature modifier comprising a surfactant.

19. The method of claim 18, wherein the surfactant comprises one selected from the group consisting of anionic surfactants, cationic surfactants, and zwitterionic surfactants.

20. The method of claim 16, further comprising a solid-liquid phase temperature modifier comprising a non-surface active organic salt.

21. A method comprising:
providing a treatment fluid comprising a glycerine carbonate-modified water soluble cellulose ether and a surfactant; and
placing the treatment fluid in a subterranean formation penetrated by a wellbore.

22. The method of claim 21, wherein the water soluble cellulose ether comprises methyl cellulose.

23. A method comprising:
providing a treatment fluid comprising an organic carbonate-modified water soluble cellulose ether and a surfactant; and
placing the treatment fluid in a subterranean formation penetrated by a wellbore to provide fluid loss control.

24. A method comprising:
providing a treatment fluid comprising an organic carbonate-modified water soluble cellulose ether and a surfactant or a non-surface active organic salt; and
placing the treatment fluid in a subterranean formation penetrated by a wellbore to reduce water influx into the wellbore.

25. A method comprising:
providing a first treatment fluid comprising an organic carbonate-modified water soluble cellulose ether and a surfactant or a non-surface active organic salt;
placing the first treatment fluid in a first portion of a subterranean formation penetrated by a wellbore; and
placing a second treatment fluid in the wellbore, wherein the second treatment fluid is diverted away from the first portion of the subterranean formation.
